(19) United States
(12) Patent Application Publication
(10) Pub. No.: US 2006/0209380 A1
(43) Pub. Date: Sep. 21, 2006

(54) Method of manufacturing and aligning an etalon

(76) Inventor: Herman Philip Godfried, Amsterdam (NL)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/548,585

(22) PCT Filed: Mar. 12, 2004
(86) PCT No.: PCT/IB04/00700

§ 371 Date: Apr. 10, 2006

(30) Foreign Application Priority Data
Mar. 12, 2003 (GB) 0305689.2

(51) Int. Cl. G02F 1/03

(52) U.S. Cl. 359/260

(57) ABSTRACT

A method of optimizing the alignment between peaks in an etalon transmission spectrum and a periodic lock frequency grid such as the ITU grid is disclosed. The method determines and implements a value for the effective etalon thickness, which generates suitable periodicity in the etalon transmission spectrum and simultaneously aligns an appropriate etalon transmission peak, with a predetermined fractional interference order, to a predetermined frequency in the periodic lock frequency grid. The method may also adjust the value of the fractional interference order in an iterative process. The method can be used in manufacturing a wavelength locker containing an etalon.

### BACKGROUND OF THE INVENTION

THIS invention relates to a method of manufacturing and aligning an etalon of the kind suitable for wavelength or frequency locking applications.

The current invention applies mainly to etalons used as wavelength lockers in WDM (Wavelength Division Multiplexing) or DWDM (Dense Wavelength Division Multiplexing) applications in combination with tunable lasers. Such etalons are typically solid etalons. The lasers are intended to emit radiation at a discrete set of equally spaced frequencies in accordance with the so-called ITU grid (this is based on an industry standardization specification of the International Telecommunication Union) primarily around 1550 nm.

The ITU grid is a set of different frequency grids. Each grid has equally spaced frequencies over a specific frequency range, with the spacing between adjacent frequencies set at one of the following:

| | |
|---|---|
| 200 GHz | older technology |
| 100 GHz | currently in general use |
| 50 GHz | currently installing |
| 25 GHz | currently under development |
| 12.5 GHz | future development |

In this specification, the term ‘the ITU grid’ is used to refer to any one of these specific frequency grids defined in this standardization specification.

The etalons used in this application currently are manufactured according to and specified by their free spectral range (FSR). This is determined by the thickness and the material properties of the etalon, in particular its refractive index. Explicitly this is given by the equation

$$FSR = \frac{c}{2 nd cos ( θ )} \qquad ( 1 )$$

where FSR is the etalon free spectral range in terms of frequency, c is the speed of light, n is the refractive index of the etalon material and d its thickness. The angle ε is the propagation angle of the light inside the etalon with respect to the surface normal on the etalon surfaces.

Traditionally the FSR is used to characterize the transmission spectrum of an etalon as a function of frequency. Ideally, for an etalon with a constant refractive index, this consists of a periodic function with equidistant transmission peaks and valleys.

In reality the refractive index (n) is slightly wavelength dependent (written n_{ν}, this is called dispersion) and as a consequence the FSR according to equation (1) has a wavelength dependency. This in turn leads to a variation in the distance between the peaks in the etalon transmission spectrum. Therefore the etalon, which is used as a wavelength locker, will have a lock frequency that is somewhat displaced from the truly equidistantly spaced ITU grid. In (D)WDM applications this must then be compensated for by adding a tabulated error signal, which depends on the actual ITU frequency, to the feedback signal of the electronic circuit used to regulate the (D)WDM laser frequency. Since the voltage swing of the feedback electronics is limited this clearly limits the range of ITU frequencies the feedback electronics can accommodate and also limits the stability of the feedback loop.

The etalon is used to measure the laser frequency, and controls it only indirectly via an electronic feedback loop. In normal practice, the etalon is placed in the path of a secondary beam from the laser, either a portion split off from the primary beam by a partial reflector, or in the leakage out of the back end of the laser. The intensity of this secondary beam is regulated (by some other feedback system) to be constant, so that the transmitted intensity through the etalon is dependent on the etalon transmission as a function of the incident laser frequency.

In many instances, the maximum of the etalon transmission is not set to one of the ITU (or other) frequencies—at this position the variation in intensity with wavelength drift is very small (the first derivative is 0)—but is set such that the intended frequency coincides part way up the shoulder of the peak. In other instances the maximum of the etalon peak transmission is set to one of the ITU (or other) frequencies. For instance as revealed in FibreSystems Europe, April 2002 issue, p. 31, in the Optical Phase Locked Loop technology as used in the Gridlocker tunable laser produced by Fiberspace Inc. (of 21210 Erwin Street, Woodland Hills, Calif. 91367), the maxima of the transmission spectrum of an etalon are used to lock the laser frequencies to the ITU (or other) frequencies.

In yet another setup an etalon is placed internally inside the cavity of a ((D)WDM) laser and thus allows laser resonance at those frequencies corresponding to the maxima in the transmission spectra. This is effectuated by the fact that the etalon, which is placed inside the laser cavity with its normal to the reflecting surfaces at some non-zero angle of inclination to the incoming laser beam axis, will incur extra losses for those oscillation modes of the cavity whose frequencies do not correspond to the transmission maxima of the etalon, thus precluding laser oscillation on any frequency other than those corresponding to the maxima in the transmission curve of the etalon. In the application of locking to the ITU (or other) frequencies the etalon is manufactured and aligned such that the maxima of the transmission spectrum correspond to the ITU (or other) frequencies.

There are a range of design criteria for etalons including dispersion, thermal sensitivity and stability, size (compactness), ease of manufacture, cost and ruggedness. Compared with air-gap etalons, solid etalons generally provide compactness, ease of manufacture and ruggedness, whilst solid diamond etalons potentially offer further compactness, thermal stability and other benefits.

The design of an etalon for a particular application is substantially complicated by the effect of dispersion, without which a simple analytical approach would be possible. Dispersion, and particularly non-linear dispersion, has been perceived as the major limitation on the achievable performance of an etalon, the requirement for high performance generally being to minimize the maximum error at any lock point across the frequency range in the application, so as to minimize the span required in the electronic feedback circuits.

The method by which the etalons have been designed in prior art is to select the etalon thickness and thus its FSR based on some average central value for the range of frequencies of interest. Final tuning to achieve this is then done by rotating the etalon by an angle φ away from 0° (i.e. normal to the incoming beam), or to some other initial design angle which is typically a few degrees, in the actual optoelectronics package comprising the laser, the etalon and the electronics, so that the lock frequency (on the shoulder) of a transmission peak coincides with an ITU frequency. For tunable lasers a lock frequency in the middle of the band over which the laser is to be tuned is usually chosen. Rotatonal alignment of the etalon is typically accurate to 1/10 degree, and once aligned, the etalon is fixed in place by solder or epoxy and the package sealed. Note that φ represents the angle of deviation of the etalon light entry and exit surfaces away from normal to the incident light in the medium (air) external to the etalon body. Due to refraction at the surface of a solid etalon the equivalent angle θ within the etalon body is generally smaller, and for small angles the ratio between these two is fixed and dependent on the etalon material. In particular, the ratio φ/θ for fused silica is about 1.4, whilst that for diamond is about 2.4.

The problem with the approach outlined above for designing etalons is that it does not necessarily minimize the frequency errors over the range of ITU frequencies over which the tunable laser has to be locked. It is an object of the invention to provide an improved method of manufacturing and aligning an etalon.

### SUMMARY OF THE INVENTION

According to a first aspect of the invention there is provided a method of optimizing the alignment between peaks in an etalon transmission spectrum and a periodic lock frequency grid, over a specific frequency range, comprising determining and implementing a value for the effective etalon thickness (d.cos θ) which generates suitable periodicity in the etalon transmission spectrum and simultaneously aligns an appropriate etalon transmission peak, defined by the integral part of the interference order m of the etalon phase difference δ=2π(m+ε), with a predetermined fractional interference order ε, to a predetermined frequency in the periodic lock frequency grid.

According to a second aspect of the invention there is provided a method of optimizing the alignment between peaks in an etalon transmission spectrum and a periodic lock frequency grid, over a specific frequency range, comprising determining and implementing values for the effective etalon thickness (d.cos θ) and for the fractional interference order ε which together generate suitable periodicity in the etalon transmission spectrum, and aligning an appropriate etalon transmission peak, defined by the integral part of the interference order m of the etalon phase difference δ=2π(m+ε), with the precise fractional interference order ε, to a predetermined frequency in the periodic lock frequency.

In either case, the error away from the intended fractional interference order ε between the periodic lock frequency grid and the etalon transmission peaks is preferably minimized across the specific frequency range according to a selected optimization scheme.

For example, the optimization scheme may be one of:
a. minimizing the maximum error away from the intended fractional interference order ε observed at any frequency across the specific frequency range;
b. minimizing the sum of absolute errors away from the intended fractional interference order ε across the specific frequency range; and
c. achieving the least squares value of the errors away from the intended fractional interference order ε across the specific frequency range.

Typically, the periodic lock frequency grid will be the ITU grid.

Further according to the first aspect of the invention there is provided a method of manufacturing and aligning an etalon suitable for use in frequency locking applications, the method comprising:
a. establishing a set of spaced apart predetermined lock frequencies;
b. selecting a desired lock frequency in the set of predetermined lock frequencies;
c. calculating an optimized value for the integral part of the interference order m of the etalon phase difference at the selected lock frequency, using a predetermined value for ε, the fractional interference order;
d. calculating a thickness value for an etalon corresponding to the selected lock frequency, using the optimized value of m; and
e. polishing an etalon body so that the effective thickness d.cos(θ) equals the calculated thickness value.

The method may further comprise:
f) selecting an initial, estimated value for the integral part of the interference order m of the etalon phase difference at the selected lock frequency, and calculating a thickness value for an etalon corresponding to the selected lock frequency, using the selected value of m;
g) using the calculated value for the effective thickness of the etalon, calculating a set of etalon lock frequencies;
h) determining deviations between the calculated etalon lock frequencies and respective frequencies of the set of predetermined lock frequencies;
i) adjusting the selected value of m;
j) and repeating steps (f) to (i) zero or more times to optimize the correlation between the calculated etalon lock frequencies and the set of predetermined lock frequencies, thereby to obtain a value for the optimum thickness of the etalon; and
k) polishing the etalon body so that the effective thickness d.cos(θ) equals the calculated optimum thickness.

The method may include adjusting the desired lock frequency to another of the set of predetermined lock frequencies and repeating steps (f) to (i) zero or more times, thereby to minimize the overall frequency error between the set of predetermined lock frequencies and the etalon lock frequencies.

Further according to the second aspect of the invention there is provided a method of manufacturing and aligning an etalon suitable for use in frequency locking applications, the method comprising:
a. establishing a set of spaced apart predetermined lock frequencies;
b. selecting a desired lock frequency in the set of predetermined lock frequencies;
c. calculating an optimized value for the integral part of the interference order m of the etalon phase difference at the selected lock frequency, using an estimate for the value of ε, the fractional interference order;
d. calculating an optimized value for ε;
e. calculating a thickness value for an etalon corresponding to the selected lock frequency, using the optimized values of m and ε; and
f. polishing an etalon body so that the effective thickness d.cos(θ) equals the calculated thickness value.

The method may further comprise:
g. selecting an initial, estimated value for the integral part of the interference order m of the etalon phase difference at the selected lock frequency, and calculating a thickness value for an etalon corresponding to the selected lock frequency, using the selected value of m;
h. using the calculated value for the effective thickness of the etalon, calculating a set of etalon lock frequencies;
i. determining deviations between the calculated etalon lock frequencies and respective frequencies of the set of predetermined lock frequencies;
j. reducing said deviations by adjusting the value of ε;
k. adjusting the selected value of m;
l. repeating steps (g) to (k) zero or more times to optimize the correlation between the calculated etalon lock frequencies and the set of predetermined lock frequencies, thereby to obtain a value for the optimum thickness of the etalon; and
m. polishing the etalon body so that the effective thickness d.cos(θ) equals the calculated optimum thickness.

The method may include adjusting the desired lock frequency to another of the set of predetermined lock frequencies and repeating steps (g) to (k) zero or more times, thereby to minimize the overall frequency error between the set of predetermined lock frequencies and the etalon lock frequencies.

Preferably, ε is a real number between −0.5 and +0.5 representing the phase offset of the interference order of the etalon, thereby determining whether frequency locking takes place on the transmission peak (ε=0) or on either shoulder (ε< >0) of the transmission peak.

Typically, the set of spaced apart predetermined lock frequencies comprises the ITU grid.

Preferably, 0 is chosen to be in the range 0° to 20°, and preferably in the range 0° to 5°, thereby providing a means of correcting for small errors in the polished thickness of the etalon body.

The etalon may comprise a solid diamond body.

Thus the method does not merely choose an etalon with a given FSR and then align one of the etalon transmission peaks with a chosen predetermined lock frequency, but specifically chooses and optimizes the value of m, the etalon interference order for the etalon transmission peak, which is aligned with respect to any particular lock frequency in the application of the etalon. This precise alignment of the two frequency grids (the ITU grid and the etalon's own set of transmission frequencies) is then utilized to ensure that the spacing between the periodic lock frequency grid and the etalon transmission frequencies is best optimised, since both the spacing and the position of etalon transmission peaks is shifted as the effective optical path length through the etalon is adjusted (for example by rotating the etalon during mounting in the package).

Still further according to the invention there is provided a wavelength locker containing an etalon fabricated according to the method defined above, and mounted in an optoelectronics package or device.

Preferably, in such a wavelength locker the etalon is arranged to operate at a fixed temperature in combination with feedback electronics, and to provide a feedback signal to a tunable laser such that feedback corrections to regulate the laser emission frequency and compensate for deviations between a specific frequency locking point on the etalon transmission curve defined by the values of m and ε, and the matching frequency of the ITU frequency grid or other set of periodic frequencies, across a specified frequency range, do not exceed a maximum value determined by the material from which the etalon is made, such that one of the following applies:
a. for a wavelength locker utilising a fused silica etalon operating over the C-band (191.6 THz-196.2 THz), the maximum error does not exceed +/−400 MHz;
b. for a wavelength locker utilising a fused silica etalon operating over the L-band (186.4 THz-191.6 THz), the maximum error does not exceed +/−400 MHz;
c. for a wavelength locker utilising a fused silica etalon operating over the C-band and the L-band combined (186.4 THz-196.2 THz), the maximum error does not exceed +/−700 MHz;
d. for a wavelength locker utilising a diamond etalon operating over the C-band (191.6 THz-196.2 THz), the maximum error does not exceed +1-800 MHz;
e. for a wavelength locker utilising a diamond etalon operating over the L-band (186.4 THz-191.6 THz), the maximum error does not exceed +/−800 MHz; or
f. for a wavelength locker utilising a diamond etalon operating over the C-band and the L-band combined (186.4 THz-196.2 THz), the maximum error does not exceed +/−800 MHz.

Preferably, in the above defined wavelength locker one of the following applies:
a. for a wavelength locker utilising a fused silica etalon operating over the C-band (191.6 THz-196.2 THz), the maximum error does not exceed +/−250 MHz;
b. for a wavelength locker utilising a fused silica etalon operating over the L-band (186.4 THz-191.6 THz), the maximum error does not exceed +/−200 MHz;
c. for a wavelength locker utilising a fused silica etalon operating over the C-band and the L-band combined (186.4 THz-196.2 THz), the maximum error does not exceed +/−600 MHz;
d. for a wavelength locker utilising a diamond etalon operating over the C-band (191.6 THz-196.2 THz), the maximum error does not exceed +/−600 MHz;
e. for a wavelength locker utilising a diamond etalon operating over the L-band (186.4 THz-191.6 THz), the maximum error does not exceed +/−600 MHz; or
f. for a wavelength locker utilising a diamond etalon operating over the C-band and the L-band combined (186.4 THz-196.2 THz), the maximum error does not exceed +/−600 MHz.

More preferably, in the above defined wavelength locker one of the following applies:
a. for a wavelength locker utilising a fused silica etalon operating over the C-band (191.6 THz-196.2 THz), the maximum error does not exceed +/−220 MHz;
b. for a wavelength locker utilising a fused silica etalon operating over the L-band (186.4 THz-191.6 THz), the maximum error does not exceed +/−150 MHz;
c. for a wavelength locker utilising a fused silica etalon operating over the C-band and the L-band combined (186.4 THz-196.2 THz), the maximum error does not exceed +/−550 MHz;
d. for a wavelength locker utilising a diamond etalon operating over the C-band (191.6 THz-196.2 THz), the maximum error does not exceed +/−500 MHz;
e. for a wavelength locker utilising a diamond etalon operating over the L-band (186.4 THz-191.6 THz), the maximum error does not exceed +/−540 MHz; or
f. for a wavelength locker utilising a diamond etalon operating over the C-band and the L-band combined (186.4 THz-196.2 THz), the maximum error does not exceed +/−540 MHz.

These values are based on using a value of ε=−0.25, using the industry standard practice of selecting a value for ε for which the error response into the feedback electronics can be maximized. In application a tabulated error signal would have to be added to the feedback signal to compensate for the errors. Thus a properly tabulated error table comprises the data necessary to determine the behavior of the error.

According to a further aspect of the invention, allowing ε to vary gives a further degree of freedom by which the match between the periodic transmission spectrum of the etalon and the periodic frequency grid can be further enhanced.

Thus, according to the invention there is further provided an etalon having a body comprising diamond or fused silica, configured and with a design error table such that one of the following applies when the etalon is used in a wavelength locker:
a. for a fused silica etalon operating over the C-band (191.6 THz-196.2 THz), the maximum error does not exceed +/−160 MHz;
b. for a fused silica etalon operating over the L-band (186.4 THz-191.6 THz), the maximum error does not exceed +/−100 MHz;
c. for a fused silica etalon operating over the C-band and the L-band combined (186.4 THz-196.2 THz), the maximum error does not exceed +/−450 MHz;
d. for a diamond etalon operating over the C-band (191.6 THz -196.2 THz), the maximum error does not exceed +/−350 MHz;
e. for a diamond etalon operating over the L-band (186.4 THz-191.6 THz), the maximum error does not exceed +/−350 MHz; or
f. for a diamond etalon operating over the C-band and the L-band combined (186.4 THz-196.2 THz), the maximum error does not exceed +/480 MHz.

Preferably, in the above defined etalon one of the following applies:
a. for a fused silica etalon operating over the C-band (191.6 THz-196.2 THz), the maximum error does not exceed +/−120 MHz;
b. for a fused silica etalon operating over the L-band (186.4 THz-191.6 THz), the maximum error does not exceed +/−90 MHz;
c. for a fused silica etalon operating over the C-band and the L-band combined (186.4 THz-196.2 THz), the maximum error does not exceed +/−410 MHz;
d. for a diamond etalon operating over the C-band (191.6 THz -196.2 THz), the maximum error does not exceed +/−250 MHz;
e. for a diamond etalon operating over the L-band (186.4 THz-191.6 THz), the maximum error does not exceed +/−250 MHz; or
f. for a diamond etalon operating over the C-band and the L-band combined (186.4 THz-196.2 THz), the maximum error does not exceed +/−450 MHz.

More preferably, in the above defined etalon one of the following applies:
a. for a fused silica etalon operating over the C-band (191.6 THz-196.2 THz), the maximum error does not exceed +/−80 MHz;
b. for a fused silica etalon operating over the L-band (186.4 THz-191.6 THz), the maximum error does not exceed +/−80 MHz;
c. for a fused silica etalon operating over the C-band and the L-band combined (186.4 THz-196.2 THz), the maximum error does not exceed +/−390 MHz;
d. for a diamond etalon operating over the C-band (191.6 THz -196.2 THz), the maximum error does not exceed +/−150 MHz;
e. for a diamond etalon operating over the L-band (186.4 THz-191.6 THz), the maximum error does not exceed +/−200 MHz; or
f. for a diamond etalon operating over the C-band and the L-band combined (186.4 THz-196.2 THz), the maximum error does not exceed +/−430 MHz.

Further, according to this invention, the performance of an etalon and its associated frequency error table are predetermined prior to assembly into a wavelength locker package.

The benefit of this is then realized by precisely aligning a peak on the etalon transmission curve, as defined by the integral part of the interference order m of the etalon phase difference δ=2π(m+ε) and the fractional interference order ε, with a predetermined frequency of the ITU frequency grid or other set of periodic frequencies according to the design criteria of the predetermined frequency error table.

This enables greater consistency between lockers, and the opportunity to reduce the cost, duration and complexity of the test and configuration stage of the wavelength locker during or after assembly.

The etalon used in the wavelength locker may have a solid body, preferably comprising diamond.

### BRIEF DESCRIPTION OF THE DRAWINGS

FIGS. 1 to 4 are graphs showing the effect of varying ε on the maximum and minimum frequency offset error of diamond and fused silica etalons manufactured according to the method of the invention.

### DESCRIPTION OF EMBODIMENTS

The main purpose of the invention is to arrive at an optimised design and alignment procedure for manufacturing etalons suitable for (D)WDM ((Dense) Wavelength Division Multiplexing) applications, and to obtain performance near the fundamental limit for such a device. For the purposes of this Specification, the phrase “ITU grid” will be used to encompass the particular frequency grids given in the industry standardized specification of the International Telecommunication Union, but those skilled in the art will recognize that this also encompasses any other periodic frequency grids that may be used or defined by standards where etalons may be used in the feedback control system.

An optimised design and alignment is achieved in this context when the error, that is the difference between the set of etalon lock frequencies and the ITU grid frequencies, is minimal for a given frequency range. The minimization can be either for the maximum frequency error or some other significant quantity such as the rms frequency error measured over the frequency range of interest to the user. In some applications maximization of the range of frequencies for which some value for the maximum absolute error or the rms error is not exceeded is the preferred optimization.

In principle the method of the invention is applicable to any form of etalon used in this type of application, but it is particularly relevant when used with diamond etalons. This is because the dispersion of a diamond etalon is such that using the method of the invention allows the diamond etalon to operate as a frequency locker over a much wider frequency band than was previously possible.

Prior art merely constructs a device with some optimised spacing of the etalon transmission peaks over the frequency range of interest, and then allows this to be modified by rotating the etalon whilst a largely arbitrary match, (with a previously determined value of ε), is achieved between an etalon transmission peak and a target frequency usually somewhere near the middle of the periodic lock frequency grid.

The value of ε in prior art is normally predetermined at a value selected to maximize the error signal, seen as a variation in etalon transmission intensity, for a particular frequency error. This depends amongst other things on the method chosen to lock the output frequencies of the (D)WDM laser to the ITU (or other) grid. When a locking point on the shoulders (slopes) of the transmission peaks is selected, this corresponds to a value of ε different from 0 and maximizing the error signal for a particular choice of epsilon can be achieved by applying a coating with suitable reflectivity to the surfaces of the etalon. Typically ε is taken in the range of −0.25 to +0.25.

A prior art device is thus specified only by its free spectral range (FSR) and the error in that quantity. This implies that over a range of frequencies the frequency deviation is determined by the maximum allowed free spectral range error multiplied by half the number of free spectral ranges in the frequency range. For a nominally 50 GHz C-band etalon made from fused silica typical (commercial) specifications for the free spectral range are: 50 GHz +/−0.02 GHz. For a laser tunable over the width of the C-band (approx. 4800 GHz) this would imply a specified frequency error of the locking frequency of max. +/−960 MHz. A tabulated error signal would then have to be added to the feedback signal to compensate for the errors, which is much larger than in the case of a wavelength locker with an etalon according to the present invention. This tabulated error table needs to be derived for each wavelength locker device individually and then configured into the device for stand-alone operation, during assembly and test phase of the wavelength locker.

In contrast, a preferred method of this invention selects the target effective thickness of the etalon, d cos(θ), to optimize the match between the etalon transmission peaks and the periodic lock frequency grid according to some predetermined optimization scheme, taking account of:
a) selecting an optimum pair matching between a particular etalon transmission peak (with some predetermined value of the interference order m of the etalon) and a specific frequency in the periodic lock frequency grid, and
b) the precise optimized offset ε between the particular etalon transmission peak and the specific frequency on periodic lock frequency grid,
   and then realizes this precise peak match and offset in the final configuration.

The method of optimization, in both the case where ε is treated as a predetermined constant and the case where ε is treated as an additional variable, is generally most efficiently achieved by numerical methods using iteration. A typical sequence for iteration is to:
a) select a suitable optimization parameter for the application, such as the maximum error across the frequency range of interest;
b) obtain a spacing in the etalon transmission spectrum which matches that of the periodic lock frequency grid, minimizing the optimization parameter;
c) identify the best pairing of peaks to be precisely aligned with offset ε, further minimizing the optimization parameter;
d) in the preferred embodiment, vary ε and again further minimize the optimization parameter; and
e) iteratively cycle through stages b, c, d, to find the best solution where all parameters are optimised simultaneously to give the best value of the optimization parameter obtainable, or a value of this parameter which is considered sufficiently low for the intended application.

Those skilled in the art will understand that the method described in this document for the optimization of etalon performance is general to a very wide range of etalons.

Since the error table for the etalon is predetermined prior to assembly into the wavelength locker, it provides the designer with opportunities to modify and simplify the electronics managing and utilizing the error table, and the opportunity to simplify the test and configuration stage of individual wavelength lockers. The invention is consistent with wafer scale production and characterization of the initial etalon, producing large area wafers of diamond to the required thickness tolerance and then dicing this up into individual etalons at a later stage.

Design Rules

Thus, the way optimization is achieved relies on the realization that rotation of the etalon, and thus adjustment of the optical path length, does not merely-move a set of fixed spaced frequencies, but also slightly alters the spacing between those frequencies. The objective then is not merely to align any of the etalon lock frequencies with one of the frequencies of the (target section of the) ITU grid, or even to a specific (say central) frequency of the ITU grid, but to align a specific etalon lock frequency to a specific ITU frequency, the pairing being chosen to optimize (according to the specific optimization criteria chosen) the match of the two frequency sets across the range of interest. Those skilled in the art will understand that what follows does not affect the generality of this method, but merely provides one route by which it may be implemented.

Equation (2) below describes the transmission curve of the etalon:

$$T = \frac{1}{1 + F \cdot {sin}^{2} ( \frac{δ}{2} )} \qquad ( 2 )$$

Here T is the etalon transmission defined as the ratio of transmitted to incident power; F is a quantity, which for an ideal etalon only depends on the reflectivities of the etalon surfaces. The phase difference δ is given by:

$$δ = \frac{4 π ν}{c} {n}_{v} d cos ( θ ) \qquad ( 3 )$$

where v is the frequency of the incident light.

It can be noted explicitly that n is not a constant, rather it is a function of the frequency v. Now from equation (2) we see that the transmission T is indeed a periodic function of δ with periodicity 2π, but from equation (3) one sees that δ does not depend linearly on frequency because of the dependence of n on frequency. Also from equation (3) it follows that the etalon thickness only enters in the form of an effective thickness, d cos(θ).

When the etalon is used for locking purposes, the feedback electronics are set such that ideally the value of δ obeys the following equation:
δ=2π(m+ε) (4)
where m+ε is called the ‘interference order’, with m an integer (the integral part of the interference order) and ε (the fractional part of the interference order) some real constant between −0.5 and +0.5, which determines whether locking takes place on the transmission peaks themselves (ε=0) or on the slopes of the peaks. ε is referred to as the ‘fractional interference order’. The value of m on adjacent transmission peaks changes by 1.

What the method of the invention now does is give a prescription for δ, which minimizes the frequency error. This is accomplished by combining equations (3) and (4):

$$\frac{2 {n}_{v} ν}{c} d cos ( θ ) = m + ɛ \qquad ( 5 )$$

In theory this must be solved for all integer values of m as a function of the effective etalon thickness, d cos(θ). The value of ε is determined by the locking scheme of the laser system designer (the value of ε depends on where locking takes place, on the peaks or on the rising or trailing slopes of the peaks, and on the sharpness of the peaks, i.e. the reflectivity of the etalon surfaces).

It is noted that the approach above of solving for all integer values of m is somewhat impractical as the amount of data that needs to be handled is very large. For instance for a tunable laser in the C-band one would have to generate approximately 100 functions of frequency versus etalon thickness, which in the best case only contain 1 point of interest each (the optimum value of the effective thickness).

A much quicker approach starts from an estimated value of m for some predetermined ITU frequency (usually near the middle of the design range of frequencies of the tunable laser) by solving equation (5) for the effective etalon thickness at the ITU frequency. For an etalon with this thickness the lock frequency is then equal to the particular ITU frequency. In the next step all the locking frequencies of the other laser emission lines are calculated using the effective thickness generated above. These frequencies in general will deviate from the ITU frequencies. Now for this particular estimated value of the integer interference order m, the deviations will have a linear component, which must be minimized by varying m (note that m can only be varied in steps of 1 since it is an integer). In terms of the prior art, this is an error in the free spectral range, which must be corrected.

Once an optimum value of m has been found for this particular line, overall optimization can take place by sequentially applying the above scheme to other laser locking lines in the design frequency range. The starting values of m can be improved from the one chosen in the first step because we know that adjacent lines must have values of m, which differ by 1. Note that for the optimization scheme it may be necessary to still vary the values of m in the calculations for each line. However only a few sets of calculations are necessary to come to an overall optimum determined by the optimization criteria.

It is noted that in theory such an optimum is not necessarily achieved by setting the frequency error of any particular emission line to zero, but in practice the improvement that is achieved this way is negligible. For example for a fused silica etalon in the C-band, when minimizing for the maximum absolute value of the frequency error of all emission lines using a predetermined value of ε of −0.25, it is found that all frequency errors can be made smaller than 190 MHz using the procedure given above. When trying to improve on this by allowing some non-zero frequency error at the optimization frequency the improvements are less than 0.5 MHz in the maximum error.

An even better optimum (lower overall error) can theoretically be achieved by varying the temperature of the etalon. However the improvement thus obtained is also fairly small: for a fused silica etalon in the C-band it is found that heating the etalon to a temperature of say 80° C. would only improve the maximum error from less than 190 MHz to less than 180 MHz. For a diamond etalon at 80° C. the improvements in the maximum error would only be of order 1 MHz.

The further optimization of ε can then be used in addition to the above method, although a full solution needs to consider that the optimised pairing of the etalon transmission peaks and the frequency in the periodic set may also change as variation in ε is used to optimize the match between the etalon transmission peaks and the set of periodic frequencies according to some predetermined optimization scheme.

The route to the final optimum solution may thus be an iterative one, but such numerical iteration is relatively simple using modern computer technology, and it is relatively simple to provide an encoded form of the iteration algorithm described earlier to run on a computer.

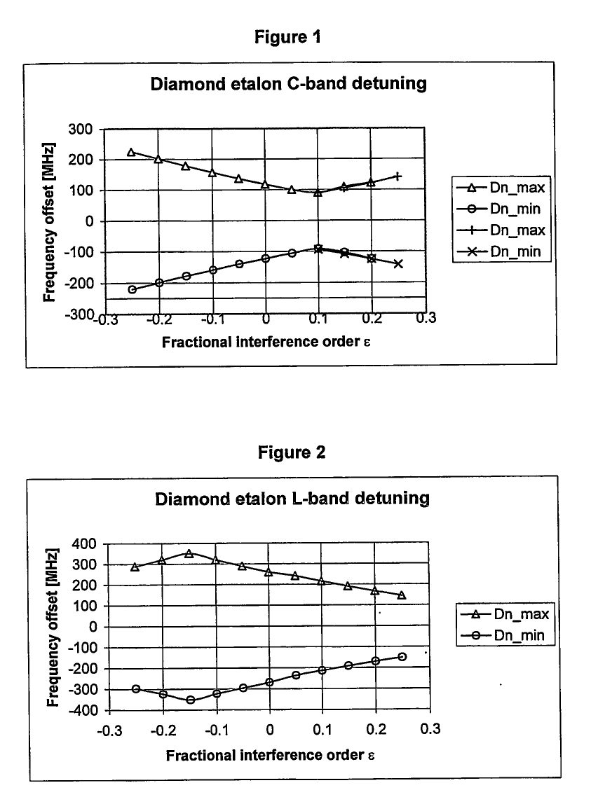

Examples of the effect of varying ε once a basic match between etalon transmission peaks and the set of periodic frequencies has been achieved are shown in FIGS. 1 to 4. The data in FIG. 1 is also shown in tabulated form in Table 1 in Appendix A.

FIG. 1 shows the effect on the maximum offset error (maximum positive error, shown as open triangles) and minimum offset error (maximum negative error, shown as open circles) in frequency match across the C band frequency range achieved between the peaks of a diamond etalon transmission curve and an ITU frequency grid with 50 GHz spacing, as a function of the fractional interference order ε. Optimization of the other parameters has made the maximum and minimum frequency offset error values nearly symmetric for each value of ε. The minimum range of frequency offset error, with a total range 183 MHz and a maximum absolute error of 93 MHz, is achieved at ε=0.1.

The datapoints marked with open triangles and open circles respectively represent the maximum and minimum offset errors achieved when the particular matched pairs of frequencies for each point form a closely spaced group with m_{offset} values in the range of −25 to 40 (see Table 1, Appendix A). m_{offset} here represents the displacement of the matched peak in the ITU grid away from the center frequency of the C band frequency range, with the negative sign denoting displacement to lower frequencies. The data points marked by + and x symbols on the shorter curves show the frequency offsets achieved by moving the pair matching into another region of the C band, with m_{offset} values in the range 29-32. Note that the meshing between the two frequency grids is displaced by substantially less than one frequency spacing in order to substantially move the position of the precisely matched frequency pair. Note that the range of ε has been restricted to +/−0.25 for other practical performance reasons, although larger absolute values may be possible.

FIG. 2 shows the effect on the maximum and minimum offset errors in frequency match across the L band frequency range achieved between the peaks of a diamond etalon transmission curve and an ITU frequency grid with 50 GHz spacing, as a function of the deliberate offset ε. Optimization of the other parameters has made the maximum and minimum frequency offset error values nearly symmetric for each value of ε. The minimum range of frequency offset error, with a total range of 297 MHz and a maximum absolute error of 152 MHz, is achieved at ε=0.25.

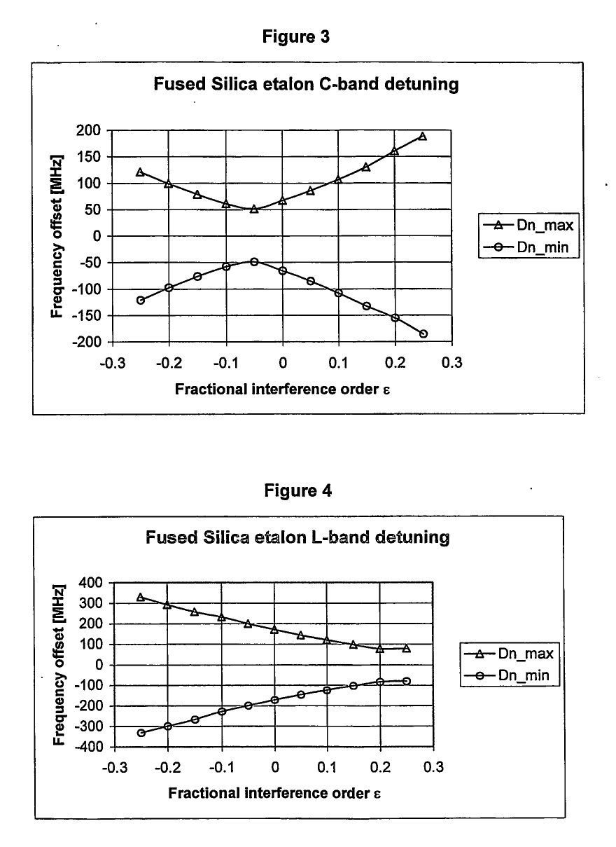

FIG. 3 shows the effect on the maximum and minimum offset errors in frequency match across the C band frequency range achieved between the peaks of a fused silica etalon transmission curve and an ITU frequency grid with 50 GHz spacing, as a function of the deliberate offset ε. Optimization of the other parameters has made the maximum and minimum frequency offset error values nearly symmetric for each value of ε. The minimum range of frequency offset error, with a total range of 100 MHz and a maximum absolute error of 52 MHz, is achieved at ε=−0.05. In order to achieve sufficient error response it may be advantageous to use a larger value of epsilon, but even at ε=−0.1 the range of frequency offset error is only 120 MHz, with a maximum absolute error of 62 MHz.

FIG. 4 shows the effect on the maximum and minimum offset errors in frequency match across the L band frequency range achieved between the peaks of a fused silica etalon transmission curve and an ITU frequency grid with 50 GHz spacing, as a function of the deliberate offset ε. Optimization of the other parameters has made the maximum and minimum frequency offset error values nearly symmetric for each value of ε. The minimum range of frequency offset error, with a total range of 158 MHz and a maximum absolute error of 79 MHz, is achieved at ε=+0.25.

The achievable performance of fused silica and diamond etalons in the C, L and C+L band combined when using the method of the invention is then summarized in Table 2 in Appendix A. In order to derive this data, at each value of ε the maximum and minimum offset error values are calculated, the one with the larger absolute value determined, and absolute value recorded as the Maximum Detuning value for that value of ε. The table then shows the minimum value achievable for the Maximum Detuning value, together with the corresponding value of ε, for the different configurations of etalon material and frequency band. The final column shows the surface reflectivity which best optimizes the error response of the etalon under these conditions.

The reflectivity can be adjusted in the device by using, for example, suitable coatings, although it may not always be required to work at the optimum reflectivity but instead use an uncoated etalon or some reflectivity intermediate between the two. In the case of the fused silica C-band, the minimum value of the maximum detuning is achieved at ε=−0.05, but the value achieved at ε=−0.1 is not much higher (61 compared with 51), so the reflectivity for ε=−0.1 is given as this may generally be a better combination to use in practice, allowing a lower optimum reflectivity.

To summarize, by applying the method of the invention one ends up with a design value for the effective etalon thickness which matches a specific etalon transmission peak (with a given value of m) to a specific lock frequency in the frequency grid (e.g. an ITU grid). For the particular material and for the tuning range of the laser, this particular match of frequencies will result in frequency errors between the etalon transmission frequencies and the lock frequency grid over the frequency range of interest which are optimised as well as is possible according to the optimization scheme chosen as desirable.

Manufacturing and Alignment Procedure

Once the required value of the effective etalon thickness (d cos(θ)) is known one has to polish the etalon to the required thickness. This physical thickness is determined by the requirements on the angle of incidence of the light incident on the etalon (i.e. the nominal angle of incidence and its tolerances). This obviously depends on the laser system manufacturer's design. Therefore the etalon manufacturer has to manufacture the etalon according to:

$$d = \frac{{d}_{eff}}{cos ( θ )} \qquad ( 6 )$$

where it is noted that the angle θ is the internal angle of propagation of the light inside the etalon with respect to the etalon surface normal. The design usually specifies the tolerances on the external angle of incidence of the light. From these one may then determine the manufacturing tolerance on the etalon thickness by applying Snell's law to the refraction at the etalon.

As mentioned earlier, the ratio φ/θ for fused silica is about 1.4, whilst that for diamond is about 2.4. making the effective thickness of a diamond etalon, d.cos(θ), vary more slowly with φ and thus making diamond easier to adjust and more stable to small beam angle variations. The initial design value of φ is non-zero to allow errors in manufacture of the etalon thickness to be adjusted for by making the etalon slightly thicker and then reducing the effective thickness according to d.cos(θ).

Alignment in the laser package must be done now for the line of optimization, that is the specific ITU grid line for which the frequency error was set equal to zero in the optimization procedure. Alignment is achieved by rotating the etalon such that the specific laser lock frequency will be equal to the ITU grid frequency. Alternatively, one could use any other frequency pairing arising from the desired configuration, and rotate the etalon such that the chosen lock frequency of the laser deviates from the matching ITU grid frequency by the computed amount, both in magnitude and sign.

The design, manufacture and alignment of etalons for wavelength lockers according to the method of the invention results in globally optimised frequency errors that depend on the intended application of the wavelength locker. In DWDM applications these errors must then be compensated for by adding a tabulated error signal, which depends on the actual ITU frequency, to the feedback signal used to regulate the DWDM laser frequency. Since the voltage swing of the feedback electronics is limited this clearly limits the capture range of the feedback electronics and also limits the stability of the feedback loop. Having suitably optimized values of the tabulated error signals is clearly desirable in both respects.

### EXAMPLE 1

An uncoated diamond etalon used for DWDM wavelength locking on a 50 GHz ITU grid was produced where the etalon was designed according to the method of this invention so as to minimize the maximum value over the C-band frequency range (191.6 THz-196.2 THz) of the deviation between the frequency grid defined by the shoulders at a selected value of ε of the transmission peaks of the etalon and the equispaced ITU frequency grid with a frequency spacing of 50 GHz.

To this end the first step was selection of a trial value of ε of 0.2 and selection of a trial value for m at the middle of the C-band at a frequency of 193.9 THz. A trial value of the effective thickness d.cos(θ) was chosen so as to make the free spectral range of the etalon equal to 50 GHz according to eq. 1. From this value for the effective thickness d.cos(θ) the trial value of m was found to be 3878. In the next step a corrected effective thickness d_{eff} and the corresponding etalon lock frequencies were calculated for an etalon with a non-integral part of the interference order ε equal to 0.2 and set so that the etalon lock frequency at the middle of the C-band coincided with the ITU frequency at 193.9 THz.

It was then found that the actual free spectral range of the etalon was in error and the lock frequency at the high frequency end of the C-band for an etalon produced according to this specification would be offset from the ITU defined frequency by more than 10.3 GHz. In the next step the value of m was adjusted so as to give corrected values for d_{eff}, which resulted in the smallest value of the maximum deviation over the C-band between the etalon lock frequencies and the ITU grid defined frequencies. This resulted in a maximum deviation of less than 244 MHz. In the final step this procedure was repeated for ITU grid frequencies other than the frequency at the middle of the C-band such that the effective thickness of the etalon was optimized for those frequencies as well. This resulted in an overall minimum value for the maximum deviation of the etalon lock frequencies from the ITU defined frequency grid of 125 MHz.

The etalon in question had a design effective thickness of 1.25124 mm. It was to be used as a wavelength locker where the incident laser beam would impinge on the etalon at an incidence angle of 2±1.5 degrees. Consequently the etalon had to be manufactured with a physical thickness in the range of 1.25125 to 1.25165 mm.

An etalon was manufactured according to the above guidelines using single crystal CVD diamond material prepared according to the method disclosed in co-pending patent application PCT/IB03/05281.

After synthesis, the single crystal CVD diamond stones were removed from the substrate and were sawn into a number of diamond plates. Each diamond plate was subsequently polished to just above the desired thickness near 1.25 mm. The plates were then individually fine polished on one side on a cast iron impregnated with fine diamond grit polishing wheel that had been carefully prepared. The tang used was very rigid and held the diamond against a reference surface that ran parallel to the scaife surface.

After turning over each diamond plate the other side was polished to the desired flatness and parallelism on the same scaife, taking care at this stage to bring the thickness to that required for the final etalon. Parallelism was measured using a commercial Zygo GPI interferometric instrument based on the Fizeau principle, well known to those skilled in the art. The thickness was measured initially by a digital thickness meter made by Heidenhain. Measurement of the free spectral range (FSR) was used as a final stage check. Final thickness was achieved by measuring the linear removal rate, which because of the quality of the material was very constant, and then polishing for the necessary predicted time. Other methods of etching or material removal have also been used in similar trials, including ion beam etching, plasma etching or reactive ion etching.

A diamond plate from the above synthesis process was used to further characterize the achievable surface Ra. The surface was carefully polished on both sides using the technique described above and then measured for surface Ra using the Zygo NewView 5000 scanning white light interferometer. Measurements were taken from nine locations on each side of the sample, each measurement being taken on a 1 mm×1 mm area with the nine areas forming a 3 mm×3 mm grid on the centre of each side, and then the statistical mean of the nine measurements was calculated. The measured Ra on side A was 0.57 nm±0.04 nm, and on side B was 0.51 nm±0.05 nm.

Subsequently each plate was cut up by a laser into discrete units. One or several of the side faces were then polished, such that the side faces were perpendicular to the front and back faces, although this is not always required by the application.

The resultant diamond etalons were 1.5 mm square, 1.25145 mm thick, made to the following tolerances:
thickness: ±0.2 μm
parallelism: ±5 arcsec
surface Ra: <1 nm

Etalons with reflectivity other than the intrinsic reflectivity determined by the refractive index of diamond and that of air, were manufactured by depositing partially reflecting coatings on both the front and rear faces of the etalon. The required reflectivity of the coating was calculated from the combination of the intended transmission value T and the value of the fractional interference order ε, which determines the position of the lock point on the transmission curve.

For 50% transmission and ε=0.2 the required reflectivity value was calculated as 32.7%. The reflectivity obtained using partial reflecting coatings on the diamond etalons was measured and shown to have a reflectivity equal to this value with an accuracy better than ±1% over the complete C-band.

Two etalons (etalon #1 and etalon #2) were subsequently mounted on a temperature regulated mechanical stage with angular adjustment capability and positioned in the collimated output laser beam from a single mode optical fiber connected to a tunable laser, made by Ando, type AQ4321 D, whose frequency could be adjusted to arbitrary values within both the C-and L-band. Frequency of the laser output was measured with a Burleigh WaveMeter, type WA-1650, with absolute readout accuracy to within 30 MHz. The mechanical stage temperature was regulated to be 25° C.+/−0.05° C. Temperature readout was accurate to 0.01° C. Although absolute accuracy was only 0.1° C., care was taken to always make measurements at the same values on the temperature readout.

For alignment of the etalon the frequency of the output laser was set at 191600.00 GHz as measured on the WA-1650 WaveMeter. The mechanical stage was then adjusted to an angle such that the transmission of the etalon was 50% as measured with a photodiode mounted behind the etalon. The angles of the surface normal of the etalons with respect to the incoming collimated laser beam thus found were 0.8 degrees and 2.7 degrees for etalon #1 and etalon #2, respectively. Subsequently the frequencies of the ITU channels in the C-band were compared to the frequencies of the laser output, as measured by the WA-1650 WaveMeter. for which the etalon transmission was 50%.

Thus it was found that for both etalons the maximum error in frequency was always smaller than 137 MHz. Maximum deviation occurred at a frequency of 193200 GHz+/− 200 MHz and 193350 GHz +/−250 MHz, respectively. This accuracy was limited by the accuracy of the Burleigh Wash. 1650 WaveMeter to measure the deviation of the laser output frequency from the ITU frequency grid. Thus it was found that over the C-band for a diamond etalon with ε=0.2 maximum frequency deviation of the lock frequency would not exceed 137 MHz.

### APPENDIX A

TABLE 1

| | | | Δν_max | Δν_min | | Δν_max | Δν_min |
|---|---|---|---|---|---|---|---|
| Epsilon | m_0 | m_offset | [MHz] | [MHz] | m_offset | [MHz] | [MHz] |
| −0.25 | 3861 | −25 | 225.1 | −220.5 | | | |
| −0.2 | 3861 | −26 | 201.1 | −198.7 | | | |
| −0.15 | 3861 | −27 | 178.4 | −178 | | | |
| −0.1 | 3861 | −28 | 157 | −158.7 | | | |
| −0.05 | 3861 | −29 | 137 | −140 | | | |
| 0 | 3861 | −30 | 118.3 | −122.7 | | | |
| 0.05 | 3861 | −31 | 101 | −106.6 | | | |
| 0.1 | 3861 | −33 | 90.5 | −92 | 32 | 88.7 | −93.8 |
| 0.15 | 3861 | −40 | 109 | −104 | 31 | 104.7 | −108.9 |
| 0.2 | 3861 | −46 | 122.6 | −124.5 | 30 | 122 | −125.1 |
| 0.25 | 3861 | | | | 29 | 140.6 | −142.4 |

TABLE 2

| | Minimum | | |
|---|---|---|---|
| | value of Max | | |
| | Detuning (MHz) | Epsilon | Reflectivity |
| Diamond C-band | 92 | 0.1 | 54.5% |
| Diamond L-band | 151 | 0.25 | 17% |
| | | | (UC) |
| Diamond C + L-band | 419 | −0.25 | 17% |
| | | | (UC) |
| Fused silica C-band | 51 | −0.05 | 55% |
| | | | (for eps = −0.1) |
| Fused silica L-band | 79 | 0.25 | 17% |
| Fused silica C + L-band | 376 | −0.25 | 17% |

1-26. (canceled)

27. A method of optimizing alignment between peaks in an etalon transmission spectrum and a periodic lock frequency grid, over a specific frequency range, comprising:
determining and implementing a value for the effective etalon thickness (d.cos θ) which generates suitable periodicity in the etalon transmission spectrum and simultaneously aligns an appropriate etalon transmission peak, defined by the integral part of the interference order m of the etalon phase difference δ=2π(m+ε), with a predetermined fractional interference order ε, to a predetermined frequency in the periodic lock frequency grid,
wherein the error away from the intended fractional interference order ε between the periodic lock frequency grid and the etalon transmission peaks is minimized across the specific frequency range according to a selected optimization scheme.

28. A method of optimizing alignment between peaks in an etalon transmission spectrum and a periodic lock frequency grid, over a specific frequency range, comprising:
determining and implementing values for the effective etalon thickness (d.cos θ) and for the fractional interference order ε which together generate suitable periodicity in the etalon transmission spectrum; and
aligning an appropriate etalon transmission peak, defined by the integral part of the interference order m of the etalon phase difference δ=2π(m+ε), with the precise fractional interference order ε, to a predetermined frequency in the periodic lock frequency grid,
wherein the error away from the intended fractional interference order ε between the periodic lock frequency grid and the etalon transmission peaks is minimized across the specific frequency range according to a selected optimization scheme.

29. A method according to claim 27 or claim 28, wherein the optimization scheme is one of:
a. minimizing the maximum error away from the intended fractional interference order ε observed at any frequency across the specific frequency range;
b. minimizing the sum of absolute errors away from the intended fractional interference order ε across the specific frequency range; and
c. achieving the least squares value of the errors away from the intended fractional interference order ε across the specific frequency range.

30. A method according to claim 27 or claim 28, wherein the periodic lock frequency grid is the ITU grid.

31. A method of manufacturing and aligning an etalon suitable for use in frequency locking applications, the method comprising:
a. establishing a set of spaced apart predetermined lock frequencies;
b. selecting a desired lock frequency in the set of predetermined lock frequencies;
c. calculating an optimized value for the integral part of the interference order m of the etalon phase difference at the selected lock frequency, using a predetermined value for ε, the fractional interference order;
d. calculating a thickness value for an etalon corresponding to the selected lock frequency, using the optimized value of m; and
e. polishing an etalon body so that the effective thickness d.cos(θ) equals the calculated thickness value.

32. A method according to claim 31, further comprising:
f. selecting an initial, estimated value for the integral part of the interference order m of the etalon phase difference at the selected lock frequency, and calculating a thickness value for an etalon corresponding to the selected lock frequency, using the selected value of m;
g. using the calculated value for the effective thickness of the etalon, calculating a set of etalon lock frequencies;
h. determining deviations between the calculated etalon lock frequencies and respective frequencies of the set of predetermined lock frequencies;
i. adjusting the selected value of m;
j. repeating operations (f) to (i) zero or more times to optimize the correlation between the calculated etalon lock frequencies and the set of predetermined lock frequencies, thereby to obtain a value for the optimum thickness of the etalon; and
k. polishing the etalon body so that the effective thickness d.cos(θ) equals the calculated optimum thickness.

33. A method of manufacturing and aligning an etalon suitable for use in frequency locking applications, the method comprising:
a. establishing a set of spaced apart predetermined lock frequencies;
b. selecting a desired lock frequency in the set of predetermined lock frequencies;
c. calculating an optimized value for the integral part of the interference order m of the etalon phase difference at the selected lock frequency, using an estimate for the value of ε, the fractional interference order;
d. calculating an optimized value for ε;
e. calculating a thickness value for an etalon corresponding to the selected lock frequency, using the optimized values of m and ε; and
f. polishing an etalon body so that the effective thickness d.cos(θ) equals the calculated thickness value.

34. A method according to claim 33, further comprising:
g. selecting an initial, estimated value for the integral part of the interference order m of the etalon phase difference at the selected lock frequency, and calculating a thickness value for an etalon corresponding to the selected lock frequency, using the selected value of m;
h. using the calculated value for the effective thickness of the etalon, calculating a set of etalon lock frequencies;
i. determining deviations between the calculated etalon lock frequencies and respective frequencies of the set of predetermined lock frequencies;
j. reducing said deviations by adjusting the value of ε;
k. adjusting the selected value of m;
l. repeating operations (g) to (k) zero or more times to optimize the correlation between the calculated etalon lock frequencies and the set of predetermined lock frequencies, thereby to obtain a value for the optimum thickness of the etalon; and
m. polishing the etalon body so that the effective thickness d.cos(θ) equals the calculated optimum thickness.

35. A method according to claim 31 or claim 33, wherein ε is a real number between −0.5 and +0.5 representing the phase offset of the interference order of the etalon, thereby determining whether frequency locking takes place on the transmission peak (ε=0) or on either shoulder (ε< >0) of the transmission peak.

36. A method according to claim 31 or claim 33, wherein the set of spaced apart predetermined lock frequencies comprises the ITU grid.

37. A method according to claim 32 including adjusting the desired lock frequency to another of the set of predetermined lock frequencies and repeating operations (f) to (i) zero or more times, thereby to minimize the overall frequency error between the set of predetermined lock frequencies and the etalon lock frequencies.

38. A method according to claim 34 including adjusting the desired lock frequency to another of the set of predetermined lock frequencies and repeating operations (g) to (k) zero or more times, thereby to minimize the overall frequency error between the set of predetermined lock frequencies and the etalon lock frequencies.

39. A method according to claim 31 or claim 34, wherein θ is chosen to be in the range 0° to 20°, thereby providing correcting for small errors in the polished thickness of the etalon body.

40. A method according to claim 31 or claim 34, wherein the etalon comprises a solid diamond body.

41. A wavelength locker containing an etalon fabricated according to the method defined in claim 31 or claim 34 and mounted in an optoelectronics package or device.

42. A wavelength locker according to claim 41, wherein the etalon is arranged to operate at a fixed temperature in combination with feedback electronics, and to provide a feedback signal to a tunable laser such that feedback corrections to regulate the laser emission frequency and compensate for deviations between a specific frequency locking point on the etalon transmission curve defined by the values of m and ε, and the matching frequency of the ITU frequency grid or other set of periodic frequencies, across a specified frequency range, do not exceed a maximum value determined by the material from which the etalon is made, such that one of the following applies:
a. for a wavelength locker utilizing a fused silica etalon operating over the C-band (191.6 THz-196.2 THz), the maximum error does not exceed +/−400 MHz;
b. for a wavelength locker utilizing a fused silica etalon operating over the L-band (186.4 THz-191.6 THz), the maximum error does not exceed +/−400 MHz;
c. for a wavelength locker utilizing a fused silica etalon operating over the C-band and the L-band combined (186.4 THz-196.2 THz), the maximum error does not exceed +/−700 MHz;
d. for a wavelength locker utilizing a diamond etalon operating over the C-band (191.6 THz-196.2 THz), the maximum error does not exceed +/−800 MHz;
e. for a wavelength locker utilizing a diamond etalon operating over the L-band (186.4 THz-191.6 THz), the maximum error does not exceed +/−800 MHz; or
f. for a wavelength locker utilizing a diamond etalon operating over the C-band and the L-band combined (186.4 THz-196.2 THz), the maximum error does not exceed +/−800 MHz.

43. A wavelength locker according to claim 42, wherein one of the following applies:
a. for a wavelength locker utilizing a fused silica etalon operating over the C-band (191.6 THz-196.2 THz), the maximum error does not exceed +/−250 MHz;
b. for a wavelength locker utilizing a fused silica etalon operating over the L-band (186.4 THz-191.6 THz), the maximum error does not exceed +/−200 MHz;
c. for a wavelength locker utilizing a fused silica etalon operating over the C-band and the L-band combined (186.4 THz-196.2 THz), the maximum error does not exceed +/−600 MHz;
d. for a wavelength locker utilizing a diamond etalon operating over the C-band (191.6 THz-196.2 THz), the maximum error does not exceed +/−600 MHz;
e. for a wavelength locker utilizing a diamond etalon operating over the L-band (186.4 THz-191.6 THz), the maximum error does not exceed +/−600 MHz; or
f. for a wavelength locker utilizing a diamond etalon operating over the C-band and the L-band combined (186.4 THz-196.2 THz), the maximum error does not exceed +/−600 MHz.

44. A wavelength locker according to claim 43, wherein one of the following applies:
a. for a wavelength locker utilizing a fused silica etalon operating over the C-band (191.6 THz-196.2 THz), the maximum error does not exceed +/−220 MHz;
b. for a wavelength locker utilizing a fused silica etalon operating over the L-band (186.4 THz-191.6 THz), the maximum error does not exceed +/−150 MHz;
c. for a wavelength locker utilizing a fused silica etalon operating over the C-band and the L-band combined (186.4 THz-196.2 THz), the maximum error does not exceed +/−550 MHz;
d. for a wavelength locker utilizing a diamond etalon operating over the C-band (191.6 THz-196.2 THz), the maximum error does not exceed +1-500 MHz;
e. for a wavelength locker utilizing a diamond etalon operating over the L-band (186.4 THz-191.6 THz), the maximum error does not exceed +/−540 MHz; or
f. for a wavelength locker utilizing a diamond etalon operating over the C-band and the L-band combined (186.4 THz-196.2 THz), the maximum error does not exceed +/−540 MHz.

45. An etalon having a body comprising diamond or fused silica, configured and with a design error table such that one of the following applies when the etalon is used in a wavelength locker:
a. for a fused silica etalon operating over the C-band (191.6 THz-196.2 THz), the maximum error does not exceed +/−160 MHz;
b. for a fused silica etalon operating over the L-band (186.4 THz-191.6 THz), the maximum error does not exceed +/−100 MHz;
c. for a fused silica etalon operating over the C-band and the L-band combined (186.4 THz-196.2 THz), the maximum error does not exceed +/−450 MHz;
d. for a diamond etalon operating over the C-band (191.6 THz-196.2 THz), the maximum error does not exceed +/−350 MHz;
e. for a diamond etalon operating over the L-band (186.4 THz-191.6 THz), the maximum error does not exceed +/−350 MHz; or
f. for a diamond etalon operating over the C-band and the L-band combined (186.4 THz-196.2 THz), the maximum error does not exceed +/−480 MHz.

46. An etalon according to claim 45, wherein one of the following applies:
a. for a fused silica etalon operating over the C-band (191.6 THz-196.2 THz), the maximum error does not exceed +/−120 MHz;
b. for a fused silica etalon operating over the L-band (186.4 THz-191.6 THz), the maximum error does not exceed +/−90 MHz;
c. for a fused silica etalon operating over the C-band and the L-band combined (186.4 THz-196.2 THz), the maximum error does not exceed +/−410 MHz;
d. for a diamond etalon operating over the C-band (191.6 THz-196.2 THz), the maximum error does not exceed +/−250 MHz;
e. for a diamond etalon operating over the L-band (186.4 THz-191.6 THz), the maximum error does not exceed +/−250 MHz; or
f. for a diamond etalon operating over the C-band and the L-band combined (186.4 THz-196.2 THz), the maximum error does not exceed +/−450 MHz.

47. An etalon according to claim 46, wherein one of the following applies:
a. for a fused silica etalon operating over the C-band (191.6 THz-196.2 THz), the maximum error does not exceed +/−80 MHz;
b. for a fused silica etalon operating over the L-band (186.4 THz-191.6 THz), the maximum error does not exceed +/−80 MHz;
c. for a fused silica etalon operating over the C-band and the L-band combined (186.4 THz-196.2 THz), the maximum error does not exceed +/−390 MHz;
d. for a diamond etalon operating over the C-band (191.6 THz-196.2 THz), the maximum error does not exceed +1-150 MHz;
e. for a diamond etalon operating over the L-band (186.4 THz-191.6 THz), the maximum error does not exceed +/−200 MHz; or
f. for a diamond etalon operating over the C-band and the L-band combined (186.4 THz-196.2 THz), the maximum error does not exceed +/−430 MHz.

48. A wavelength locker comprising an etalon having an associated frequency error table that is predetermined prior to assembly of the etalon into the wavelength locker.

49. A wavelength locker according to claim 48, wherein the benefit of the predetermined frequency error table of the etalon is realized by precisely aligning a peak on the etalon transmission curve, as defined by the integral part of the interference order m of the etalon phase difference δ=2π(m+ε) and the fractional interference order ε, with a predetermined frequency of the ITU frequency grid or other set of periodic frequencies according to design criteria of the predetermined frequency error table.

50. A wavelength locker according to claim 48 or claim 49, wherein the etalon has a solid body.

51. A wavelength locker according to claim 50, wherein the body comprises diamond.
